(19) United States
(12) Patent Application Publication
(10) Pub. No.: US 2003/0141004 A1
(43) Pub. Date: Jul. 31, 2003

(54) Process for sealing of a joint

(76) Inventors: Ulf Palmblad, Lund (SE); Ake Sjoberg, Lund (SE); Krister Hansson, Trelleborg (SE); Magnus Nilsson, Vellinge (SE); Nils-Erik Engstrom, Trelleborg (SE); Sven Kornfalt, Malmo (SE)

Correspondence Address: STEVENS, DAVIS, MILLER & MOSHER, L.L.P., Suite 850, 1615 L Street, N.W., Washington, DC, 20036, US

(21) Appl. No.: 10/270,163

(22) Filed: Oct. 15, 2002

(30) Foreign Application Priority Data
Jan. 25, 2002 (SE) 0200210-3

(51) Int. Cl. B32B 31/00

(52) U.S. Cl. 156/64; 156/67; 156/305

(57) ABSTRACT

A process for installation of surface elements, the surface elements comprising a core, a decorative upper surface and edges provided with joining means for mechanically locking the surface elements together. Predetermined portions of the edges are provided with a glue which is present on the edges of the surface elements in a passive dry form and which may be activated by applying a liquid. The glue is provided with an indicator means which indicator means indicates the difference between a passive glue and an activated glue. The surface elements are joined to each other by use of the joining means wherein a unit of a plurality of surface elements is formed.

The present invention relates to sealing of a joint comprising glued edges.

Prefabricated surface elements which at their edges are provided with groove and tenon are well known nowadays. As these are very easy to install, it is possible for the normal handy man to achieve this. Such elements can be constituted of massive wood, fiber board, particle board, polymeric materials, and composite materials comprising polymers and organic or inorganic fibers or particles. These are often provided with a surface layer, such as lacquer or some sort of laminate. The boards are most often installed by gluing them together via their groove and tenon. It is desired to join the separate elements so closely that the joint becomes practically invisible, which increases the moisture resistance radically. The usable life of the installed elements are hereby also increased. It is essential that glue is used excessively in order to achieve a tight joint. Any gaps will lead to that moisture may penetrate the joint with subsequent swelling of the core material closest to the joint. The glue do also have to be used to an amount that it is spill out trough the joint on the decorative side of the surface elements. The superfluous glue will of course have to be wiped off before beginning to set, which is rather time consuming.

One way of solving the problem is available on the market for some time now through different types of so-called click or snap-lock floor boards where no glue is to be used. The installation of such floor boards has become much swifter as no glue is required. The problems with these type of surface elements and panels are that relatively small spills of fluids like water may cause great damage on the installed surface elements and panels as well as sub walls and especially subfloors as the fluid will run through the joints rather rapidly due to the capillary effect. It is, of course, possible to use glue on these snap-lock type of elements as well although the problem with the time consuming cleaning during installation would remain.

It has, through the present invention, been made possible to solve the above mentioned problems so that self sealing surface elements can be achieved. The glue system can be used on any type of joint but have its greatest advantage on panels provided with tongue and grove along its edges. The glue system may also be used on joint with mechanical locking. Accordingly the invention relates to a process for installation of surface elements. The surface elements comprising a core, a decorative upper surface and edges provided with joining means for mechanically locking the surface elements together. The invention is characterized in that predetermined portions of the edges are provided with a glue which is present on the edges of the surface elements in a passive dry form and which may be activated, e.g. by applying a liquid. The performance of this liquid may be adjusted by means of different additives which adjusts parameters like evaporation rate, surface tension, viscosity and wettability. The glue is provided with an indicator means which indicator means indicates the difference between a passive glue and an activated glue. The surface elements are hereby joined to each other by use of the joining means wherein a unit of a plurality of surface element is formed. The glue is suitably a PVA glue. The glue is suitably applied on the edges as an emulsion which then is allowed to dry before the joining of the surface elements. The liquid used for reactivating the glue is suitably water. The water is advantageously mixed with alcohol since this reduces the surface tension of the liquid as well as the evaporation rate increases. A thin coat of the liquid is suitably applied on the installed surface elements wherein small amounts of the liquid will penetrate into the joints thereby moisturizing and activating the glue. The glue will hereby expand and merge over the edges of the joint and will act as sealant against further penetration of liquid. It is not necessary to actively activate the glue by applying the liquid over the installed surface elements as small amounts of liquid accidentally spilt on the installed surface elements will penetrate into the joints thereby moisturizing and activating the glue so that the glue expands and merges over the edges of the joint thereby acting as a sealant against further penetration of liquid.

The indicator means is used for assuring that the glue is properly activated during the installation procedure.

According to one embodiment of the invention the indicator means indicates the presence of the activating liquid by a change in color. This may be achieved by adding a crystalline pigment to the glue. The pigment should be of the type which changes color when bonding crystal water and it is advantageous if the crystal water is released rather easily.

According to another embodiment of the invention the indicator means is a fluorescent substance, preferably a so-called UV probe. One such UV probe that has showed to be suitable is Pyranin® which change emission spectrum in UV light between wet and dry condition.

According to yet another embodiment of the invention the indicator means is a chemiluminescent substance such as peroxide decomposition, peroxyoxalate, ion radical and electron transfer chemiluminescence.

According to yet another embodiment of the invention the indicator means indicates the presence of the activating liquid by releasing a scent.

According to yet another embodiment of the invention the indicator means indicates the presence of the activating liquid by a change in opacity. This change in opacity may be visually enhanced by applying a pigmentation of at least portions of the edge beneath the glue. It is advantageous to choose a darker color for the pigmentation or dyeing of the edge as the contrast will increase.

According to yet another embodiment of the invention the indicator means indicates the presence of the activating liquid by causing the glue to swell. This is most advantageously achieved by adding an expanding agent to the glue. One suitable expanding agent is selected from the group of cellulose derivatives.

The invention is described further in connection to enclosed drawings showing different embodiments of the invention whereby;

FIG. 1 shows a joint to a floor panel according to a first embodiment of the invention.

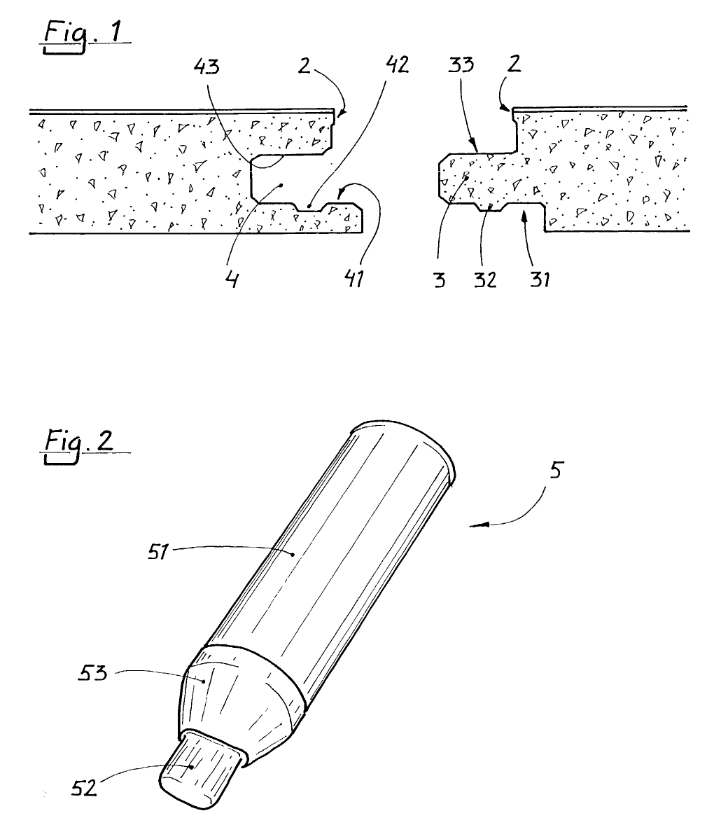

FIG. 2 shows an applicator for applying the activation fluid according to the invention.

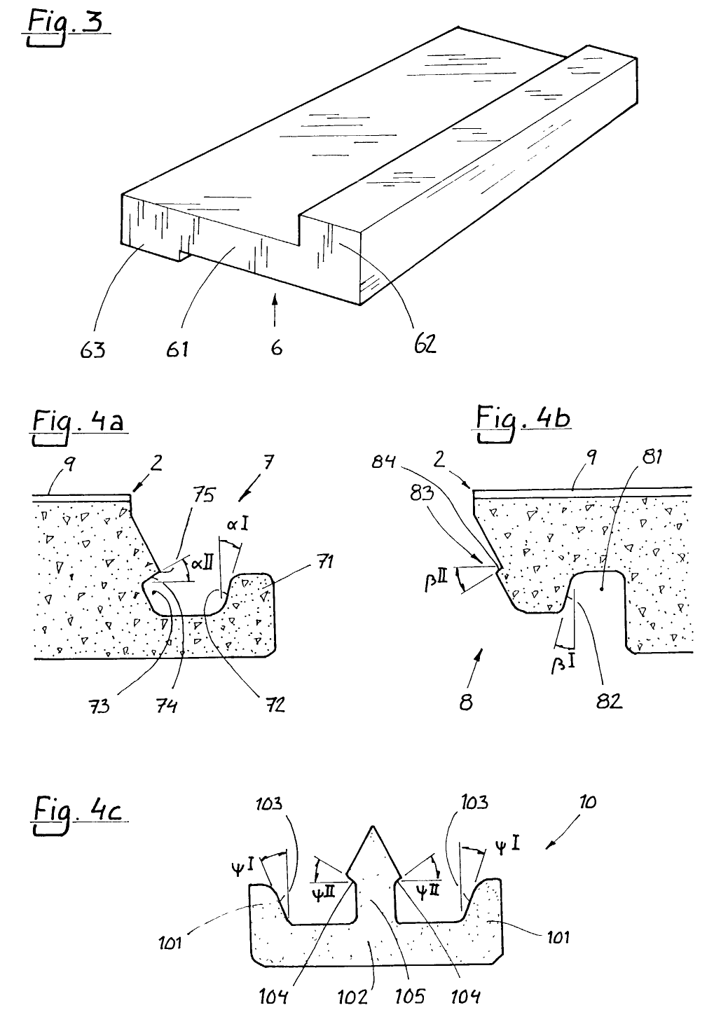

FIG. 3 shows a tapping block used during the assembly according to embodiments of the present invention.

FIGS. 4a and 4b shows panel joints according to an alternative embodiment of the present invention.

FIG. 4c shows an optional joining profile intended to be used together with a special embodiment of the joint shown in FIGS. 4a-b.

Referring now to FIG. 1 showing a first embodiment of the invention. A floor panel is provided with edges 2. One edge 2 is provided with a tongue 3 while the second edge 2, arranged on the opposite side of the panel is provided with a groove 4. The lower side 31 of the tongue 3 is provided with a protrusion 32 while the lower surface 41 of the groove 4 is provided with a recess 42, which recess 42 matches the position of the protrusion 32 so that a snap-engaging mechanical lock is achieved once the tongue 3 and groove 4 are assembled.

Predetermined surfaces of the joint are provided with a pre-applied glue which is to be activated before the assembly. The mechanical locking between the tongue 3 and groove 4 may therefore be rather shallow as their main purpose are to provide a positioning of the panels while the glue sets. This has shown to be a great advantage as most known snap-locking joints will need great force in order to snap together firmly. The pre-applied glue is preferably arranged on the upper surface 33 of the tongue 3 since this part of the joint is easy to access while the panel is close to the position where it is to be assembled with further panels. It will hereby be very easy for the installer to apply the activating fluid on the upper side of the tongue 3 and then to simply slide the panel into the correct position and snap the tongue 3 into the groove 4 of an adjacent panel. A tapping block and a hammer may be used to ensure that the protrusion 32 and recess 42 engages each other properly, thereby creating a slight tension in the joint while the glue sets. The pre-applied glue will, when properly activated, also act a bit like a lubricant which will make it easier for the installer to assemble the panels. The pre-applied glue is provided with an indicator which shows the installer that the glue is properly activated and ready for installation. The strength of the bond, once the glue has set, is mainly provided by the glue, however, the mechanical locking provided by the protrusion 32 and recess 42 may be designed to contribute considerably to the final bonding strength of the joint. The glue will also provide a sealing of the joint which will reduce the risk for water penetration.

The bonding strength will be further increased by applying the pre-applied glue to the upper surface 43 of the groove 4 i.e. the surface that will mate with glue coated surface of the tongue 3. The pre-applied glue of the upper surface 43 of the grove 4 is activated by the fluid applied on the tongue, 3 so there is no need to activate this part of the glue joint separately. It has shown during test that the bonding strength is increased more than twofold when, as described above, providing the mating surface with pre-applied glue. The glue of the mating surface is in the described embodiment of the invention arranged on a hidden surface and does therefore not need to be provided with an indicator.

As discussed above, by providing both of the mating surfaces with pre-applied glue, the bonding strength will be radically increased. One of the reasons behind this is that the glue will expand when it absorbs the activating fluid. This will force the mating surfaces closely together during the initial phase when the glue starts to set which will ensure a strong bond.

The glue used on the joint as described above is according to a preferred embodiment of the invention a PVA glue which is applied as an emulsion on predetermined surfaces of the joint to surface weight in the range 50-250 g/m² per surface calculated as dry weight. The glue is applied during manufacturing after the molding of the joint geometry. An indicator in the form of Pyranin® is added to the glue emulsion. This indicator will indicate the presence of water by changing color.

The water, which is used as activating fluid in this preferred embodiment of the invention, is applied by means of a special applicator 5 shown in FIG. 2. The applicator 5 comprises a fluid container 51 and a felt brush 52 contained in a holder 53 which is screwed on to the fluid container 51. The felt brush 52 may be spring operated so that pumping action can properly wet the felt brush 52. The felt brush 52 is shaped to match the width and shape of the surface to be coated. The felt brush 52 is preferably also designed to provide a predetermined amount of water to ensure proper activation of the pre-applied glue. This amount of water is suitably applied in a surface weight in the range 50-300 g/m². This implies that water is applied to an amount 120 g/m² to properly activate a pre-applied glue with a dry surface weight of 100 g/m². Tests has shown that the installer will have up to 10 minutes to assemble a joint after having activated the glue. A normal handy man will be able to assemble a joint within a minute if the product weighs less than 15 kg, has a format smaller than 2 m×1 m and is arranged adjacent to its assembled position. It is furthermore possible to reactivate the pre-applied glue a couple of times if the installation is interrupted by one reason or the other.

The final part of the assembly, when the panels are snapped together, is according to one special embodiment of the invention assisted by a specially designed tapping block 6 shown in FIG. 3. The tapping block 6 constitutes a mid section 61, a first edge section 62 and a second edge section 63. The first edge section 62 is shaped to fit the groove 4 edge 2 of a panel while the second edge section 63 is shaped to fit the tongue 3 edge 2 of the board. The mid section 61 will provide an area for holding the tapping block 6 in a correct position while tapping with a hammer on the rear side of the edge section in contact with the edge 2 of the panel. This will reduce the risk of hitting ones thumb with the hammer while tapping the panel into engagement with prior installed panels. It will also prevent from accidentally damaging the edge 2 of the panel with the hammer during the installation. The tapping block 6 is suitably made of a durable, strong but slightly flexible material. Among suitable materials which the tapping block 6 can be made of can be mentioned; polyamide, polyvinylchloride, polypropylene and polyethylene. The thickness of the material, especially of the edge sections 62 and 63 respectively is suitably in excess of 5 mm. The risk that the delicate edge portion of the panel is damaged during the installation is hereby radically reduced.

FIGS. 4a and 4b shows in cross-section opposite edges 2 of panels according to an alternative embodiment of the invention. The panels are provided with edges 2 which are provided with joining members. These joining members are assembled vertically. The panels are further provided with a lower side and a decorative top surface 9. A first joining member 7 comprises an upwards protruding lip 71, being parallel to the edge 2. The upwards protruding lip 71 is provided with a with a guiding surface 72, the guiding surface 72 facing the edge 2, and a locking groove 73, being parallel to the edge 2. The locking groove 73 has a locking surface facing downwards, which locking surface terminates in a locking edge. An angle αI between the guiding surface 72 and a vertical plane is 10°, while the angle αII between the locking surface 74 and a horizontal plane is 15° as seen in a perpendicular cross-section. A pre-glued surface is located between the decorative upper surface 9 and the locking edge.

A second joining member 8 comprises a groove 81, with a guiding face 82, being parallel to the edge 2, on the lower side. The guiding face 82 is facing away from the edge 2. The second joining member 8 is also provided with a locking heel 83, being parallel to the edge 2. The locking heel 83 has a locking face 84 facing upwards. An angle βI between the guiding face 82 and vertical plane is 10°, while an angle βII between the locking face 84 and a horizontal plane is 15° as seen in a perpendicular cross-section. A mating surface is located between the decorative upper surface 9 and the locking heel 83. This mating surface is suitably provided with pre-applied glue of reasons as discussed in previous embodiments.

Accordingly, the angles αI and βI are the same and the angles αII and βII arc also the same.

An optional joining profile 10, shown in FIG. 4c, may possibly constitute a junction between two adjacent second type joining members 8 of two adjacent panels. The joining profile 10 comprises two upwards protruding rims 101, being parallel to each other and distanced from each other by a center section 102. The two upwards protruding rims 101 are provided with guiding areas 103. The guiding areas 103 are facing inwards. The joining profile 101 is furthermore provided with two locking cheeks 104 arranged on an extension 105. The locking cheeks 104 has locking areas facing downwards, which locking areas terminates in a locking edge. An angle ψI between the guiding area 103 and the vertical plane is 10° and the angle ψII between the locking area and a horizontal plane is 15° as seen in a perpendicular cross-section.

The section arranged between the edges 2 and the grooves 82 has a thickness which is less than the maximum panel thickness by a recess on the lower side of the panel. The thickness of the panel is normally between 5 and 15 mm whereby a suitable depth of the recess is 1-5 mm.

The width of the locking face 84 is depending on aspects like the thickness of the panel, the material used in the core, the dimensions of the part between the locking groove 73 and the lower side and the angles αI and βI chosen. The width of the locking face 84 is typically less than 30% of the thickness of the panel which normally is between 5 and 15 mm whereby the width is less than 4.5 mm for panels with 15 mm thickness and 2.1 mm for a common panels with a thickness of 7 mm. It has, however shown to be fully sufficient with a width between 0.2 mm and 1 mm. A pre-glued surface is located on the area located above the locking edges of the optional joining profile 10.

The activating fluid is applied on the pre-glued surface of the first joining member 7. In cases where an optional joining profile 10 is used for joining two adjacent second type joining members 8, the activating fluid is applied on the half of the pre-glued surface facing the panel it is to be joined with.

The invention is not limited by the embodiments shown since these can be varied in different ways within the scope of the invention. It is for example possible to provide other known joints with pre-applied glue according to the present invention. One such known joint is known from WO 98/58142 where an embodiment shown in FIG. 1 of the WO 98/58142 publication may be provided with pre-applied glue as described above. The glue is then suitably applied on the upper surface of the tongue and suitably also on the upper surface of the groove as described in connection to FIG. 1 above. It is then activated and assembled as described in connection to FIG. 1 above.

According to another example embodiment of the present invention it is possible to provide the upper surface of the tongue as shown in FIG. 22 among other embodiments of the joint shown in WO 97/47834 with pre-applied glue in order to radically increase its performance. It is also here advantageous to provide also the upper surface of the groove with pre-applied glue. As described in connection to FIG. 1 above, the glue on the upper surface of the tongue is activated before the assembly.

It is additionally possible to provide also the lower outermost surface of the groove with pre-applied glue. Even in this case it is advantageous to provide the mating surface i.e. the lower surface of the tongue with pre-applied glue. In the case where also the lower surface of the groove is provided with pre-applied glue, also this glue is activated before the assembly. The activated glue will, in both cases act somewhat as a lubricant which will facilitate the installation considerably. The joint shown in, among others, FIG. 22 of WO 97/47834 is preferably assembled by prizing along the long side as shown in FIG. 24 of WO 97/47834 while the short sides are joined by sliding the boards along the long side joint to snap-engage the short side joints as shown in FIG. 25 of WO 97/47834. The tapping block shown in FIG. 3 of the present invention is advantageously used for tapping the short side joint into engagement. These operations are considerably facilitated by using pre-applied glue on said surfaces of the joint, the glue being activated before the assembly. The joint shown in WO 97/47834 will, of course, also be much stronger once the glue has set. The moisture resistance of the joint will also be radically improved. It is according to one alternative possible to provide only the lower surface of the groove and the mating surface i.e. the lower surface of the tongue with pre-applied glue.

According to yet another embodiment example of the present invention the joint shown in, for example, FIGS. 1, 2 and 3 of WO 94/26999 may be provided with pre-applied glue to radically increase its performance. It is also here advantageous to provide also the upper surface of the groove with pre-applied glue. As described in connection to FIG. 1 above, the glue on the upper surface of the tongue is activated before the assembly.

It is additionally possible to provide also the lower outermost surface of the groove with pre-applied glue. Even in this case it is advantageous to provide the mating surface i.e. the lower surface of the tongue with pre-applied glue. In the case where also the lower surface of the groove is provided with pre-applied glue, also this glue is activated before the assembly. The activated glue will, in both cases act somewhat as a lubricant which will facilitate the installation considerably. The joint shown in, among others, FIGS. 2a-c of WO 94/26999 is preferably assembled by prizing along the long side, while the short sides are joined by sliding the board along the long side joint to snap-engage the short side joints as shown in FIGS. 3a-c of WO 94/26999. The tapping block shown in FIG. 3 of the present invention is advantageously used for tapping the short side joint into engagement. These operations are considerably facilitated by using pre-applied glue on said surfaces of the joint, the glue being activated before the assembly. The joint shown in WO 94/26999 will, of course, also be much stronger once the glue has set. The moisture resistance of the joint will also be radically improved. It is according to one alternative possible to provide only the lower surface of the groove and the mating surface i.e. the lower surface of the tongue with pre-applied glue. It is also advantageous to have a tight fit without any play in, for example, the space marked Δ in FIG. 1b of WO 94/26999 as this will ensure a tight joint.

1. A process for installation of surface elements, the surface elements comprising a core, a decorative upper surface and edges provided with joining means for mechanically locking the surface elements together wherein predetermined portions of the edges are provided with a glue which is present on the edges of the surface elements in a passive dry form and which may bc activated by applying a liquid, the glue being provided with an indicator means which indicator means indicates the difference between a passive glue and an activated glue whereby the surface elements are joined to each other by use of the joining means wherein a unit of a plurality of surface elements is formed.

2. A process according to claim 1 wherein the glue is a PVA glue.

3. A process according to claim 2 wherein the glue is applied on the edges as an emulsion which then is allowed to dry before the joining of the surface elements.

4. A process according to claim 1 wherein the liquid is water.

5. A process according to claim 1 wherein the liquid is a mixture of water and alcohol.

6. A process according to any of the claims 1-5 wherein a thin coat of the liquid is applied on the upper surface of the installed surface elements wherein small amounts of the liquid will penetrate into the joints thereby moisturizing and activating the glue whereas the glue will expand and merge over the edges of the joint and will act as sealant against further penetration of liquid.

7. A process according to any of the claims 1-5 wherein small amounts of liquid accidentally spilt on the upper surface of the installed surface elements will penetrate into the joints thereby moisturizing and activating the glue whereas the glue will expand and merge over the edges of the joint and will act as sealant against further penetration of liquid.

8. A process according to any of the claims 1-5 wherein the indicator means indicates the presence of the activating liquid by a change in color.

9. A process according to claim 8 wherein the indicator means is a crystalline pigment.

10. A process according to any of the claims 1-5 wherein the indicator means is a fluorescent substance.

11. A process according to claim 10 wherein the indicator means is a so-called UV probe.

12. A process according to any of the claims 1-5 wherein the indicator means is a chemiluminescent substance.

13. A process according to any of the claims 1-5 wherein the indicator means indicates the presence of the activating liquid by releasing a scent.

14. A process according to any of the claims 1-5 wherein the indicator means indicates the presence of the activating liquid by a change in opacity.

15. A process according to claim 14 wherein at least portions of the edge beneath the glue is provided with pigmentation.

16. A process according to any of the claims 1-5 wherein the indicator means indicates the presence of the activating liquid by causing the glue to swell.

17. A process according to claim 16 wherein the indicator means is an expanding agent.

18. A process according to claim 17 wherein the expanding agent is a cellulose derivative.
